(19) United States
(12) Patent Application Publication
(10) Pub. No.: US 2003/0193112 A1
(43) Pub. Date: Oct. 16, 2003

(54) Method for manufacturing wrist rest apparatus

(76) Inventor: Chun Fu Kuo, Taichung Hsien (TW)

Correspondence Address: CHARLES E. BAXLEY, 5th Floor, 59 John Street, New York, NY, 10038, US

(21) Appl. No.: 10/119,436

(22) Filed: Apr. 11, 2002

(51) Int. Cl. B29C 41/22

(52) U.S. Cl. 264/255

(57) ABSTRACT

A method for manufacturing a wrist rest device includes manufacturing a prototype of the wrist rest device, and applying or spraying a gelatinous or polyurethane system material onto an outer peripheral portion of the prototype, for forming a polyurethane skin on the outer peripheral portion of the prototype. The polyurethane system material is applied onto the prototype after the prototype has been formed, such that no peripheral skirt will be formed around the wrist rest device, and no trimming processes are required for trimming or removing the peripheral skirt from the wrist rest device.

### BACKGROUND OF THE INVENTION

1. Field of the Invention

The present invention relates to a method, and more particularly to a method for manufacturing wrist rest apparatuses.

2. Description of the Prior Art

Various kinds of typical wrist rest apparatus have been developed and widely used today. U.S. Pat. No. 5,163,646 to Engelhardt, and U.S. Pat. No. 5,566,913 to Prokop, and U.S. Pat. No. 5,641,369 to Kirchhoff et al., disclose three of the typical wrist rest apparatuses and each includes a soft and comfortable outer covering layer, and an inner core made of resilient and deformable or gelatinous materials, such as gel, or polyurethane, or the other gelatinous materials, which may be sticky and which should be covered with the outer covering layer.

The soft and comfortable outer covering layer may be the woven or cotton cloth materials, such as those disclosed in U.S. Pat. No. 5,163,646 to Engelhardt, or may be the various fabric blends similar to those used in clothing fabrics, such as those disclosed in U.S. Pat. No. 5,566,913 to Prokop, or may be the nonwoven polyurethane materials, such as those disclosed in U.S. Pat. No. 5,641,369 to Kirchhoff et al.

It may take a large number of manufacturing processes, and it may take a long time to fill or to engage the resilient and deformable core into the resilient or soft and comfortable outer covering layer. For example, when applying the outer covering layer into a mold cavity with a molding process, a suction force or a vacuum apparatus is required to be provided for sucking the outer covering layer to engage with or against the inner peripheral surface of the mold cavity of the mold device. In addition, a number of skillful or specialized persons are required to manufacture such wrist rest apparatuses.

U.S. Pat. No. 4,389,454 to Horacek et al. and U.S. Pat. No. 5,662.996 to Jourquin et al., discloses the other two wrist rest apparatuses which include an outer covering layer of a lightfast polyurethane skin formed by applying or spraying a material to the inside wall of the molding device, before the soft and deformable core is filled into the molding device. The polyurethane skin may be made with a mixture comprising an organic polyisocyanate, a polyol, a chain extender, an aliphatic primary or secondary aliphatic diamine, and a catalyst, by a one-shot process in the absence of solvents.

For example, as shown in FIG. 1 of the attached drawing figures, the material for forming a skin 21 is applied or sprayed to the inside wall of the mold cavity of the molding device 80. The skin 21 should have a peripheral portion 22 provided or extended outward of the mold cavity of the molding device 80. The soft and deformable core material 23 is then filled into the molding device 80 before the other mold piece 81 is engaged onto the molding device 80 for retaining the materials for the skin 21 and the core 23 within the molding device 80, and for forming such as a pad member 20 and/or a base member 30 of the wrist rest apparatus. The peripheral portion 22 of the skin 21 is provided for allowing the sticky core material 23 to be completely received or enclosed within the skin 21.

However, as shown in FIGS. 2 and 3, after the molding processes, a peripheral skirt or flange 70 may be formed by the peripheral portion 22 of the material for the skin 21, and may be formed around the wrist rest apparatus 20, 30. A large number of man power and/or a large number of trimming processes are required to remove the peripheral skirt or flange 870 from the wrist rest apparatus 20, 30.

The present invention has arisen to mitigate and/or obviate the afore-described disadvantages of the conventional wrist rest apparatuses.

### SUMMARY OF THE INVENTION

The primary objective of the present invention is to provide a method for easily and quickly manufacturing a wrist rest apparatus.

The other objective of the present invention is to provide a method for manufacturing a wrist rest apparatus having no peripheral skirt or flange formed around the wrist rest apparatus, and for allowing the wrist rest apparatus to be manufactured without final trimming processes.

In accordance with one aspect of the invention, there is provided a method for manufacturing a wrist rest apparatus, the method comprising manufacturing a prototype of the wrist rest apparatus with a polyurethane system material, and applying another polyurethane system material onto an outer peripheral portion of the prototype, for forming a polyurethane skin on the outer peripheral portion of the prototype.

The another polyurethane system material may be sprayed onto the outer peripheral portion of the prototype.

A mold device is further provided and has a mold cavity formed therein. The polyurethane system material is filled into the mold cavity of the mold device for forming the prototype of the wrist rest apparatus.

The mold device includes a deeper chamber and a shallower recess formed therein for forming the mold cavity thereof, the method further comprising filling a first polyurethane material into the chamber of the mold device for forming a pad portion of the wrist rest apparatus. and filling a second polyurethane material into the recess of the mold device for forming a base portion of the wrist rest apparatus.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a cross sectional view illustrating a typical molding device for manufacturing the typical wrist rest apparatuses;

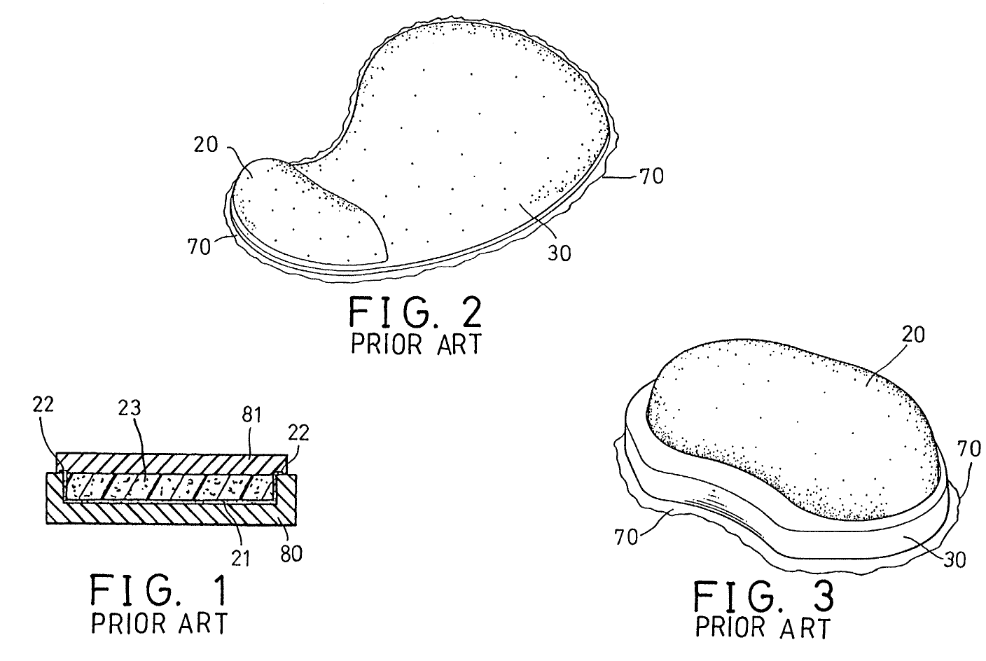

FIGS. 2, 3 are perspective views illustrating two typical wrist rest apparatuses manufactured by the typical wrist rest manufacturing methods;

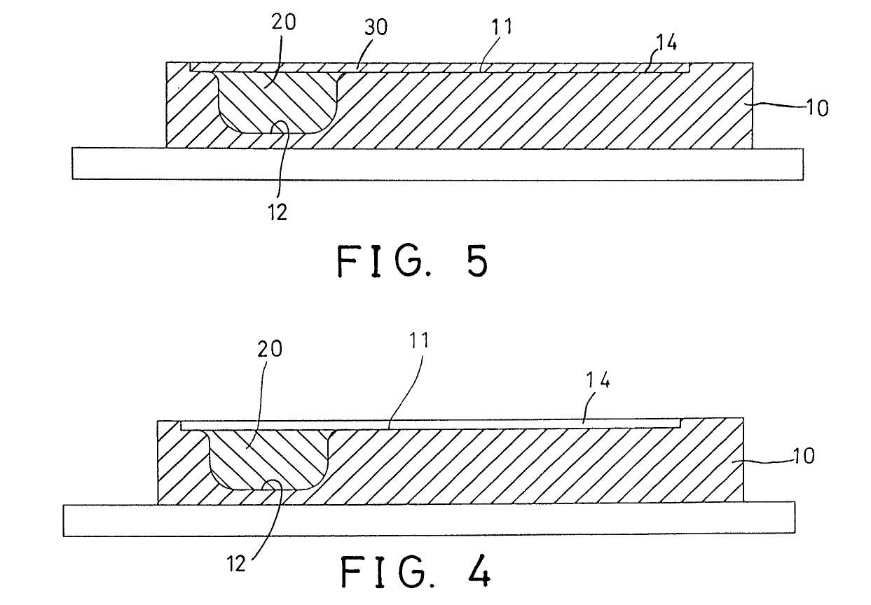

FIGS. 4, 5, 6, 7 are cross sectional views illustrating the processes of a method in accordance with the present invention for manufacturing a wrist rest apparatus; and

FIG. 8 is a perspective view of a wrist rest apparatus manufactured by the method in accordance with the present invention.

### DETAILED DESCRIPTION OF THE PREFERRED EMBODIMENT

Referring to the drawings, a method in accordance with the present invention is provided for easily and quickly manufacturing a wrist rest apparatus without forming a peripheral skirt or flange around the peripheral portion of the wrist rest apparatus, for allowing the wrist rest apparatus to be manufactured without final trimming processes.

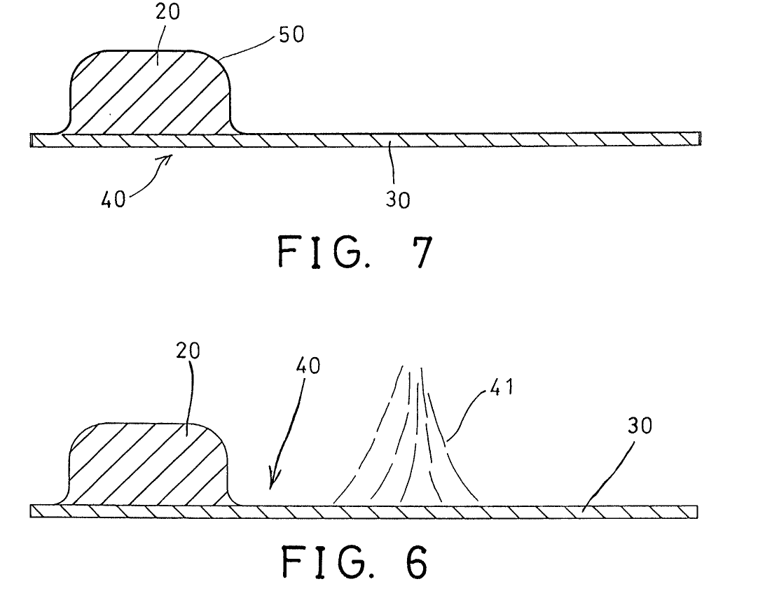

For example, as shown in FIGS. 4 and 5, one or more mold devices 10 may be provided for manufacturing or forming the prototype 40 (FIGS. 6, 7) of the wrist rest apparatus. The mold device 10 comprises a mold cavity 11 formed therein and formed according to the shapes of the wrist rest apparatuses to be formed. For example, the mold device 10 may include a deeper portion or chamber 12 having a shape corresponding to that of the pad portion 20 (FIGS. 6-8) of the wrist rest apparatus, and/or a shallower portion or recess 14 having a shape corresponding to that of the base portion 30 of the wrist rest apparatus.

As shown in FIG. 4, a resilient or soft or deformable or gelatinous material, such as gel, or polyurethane (PU), or the other gelatinous materials, is first filled into the deeper chamber 12 of the mold device 10 for forming the pad portion 20 of the wrist rest apparatus. As shown in FIG. 5, another resilient or soft or deformable or gelatinous material, such as gel, or polyurethane (PU), or the other gelatinous materials. is then filled into the shallower recess 14 of the mold device 10 for forming the base portion 30 of the wrist rest apparatus.

The pad portion 20 and the base portion 30 of the wrist rest apparatus are all manufactured with the gelatinous materials, such as the polyurethane (PU) or PU system materials, having catalysts or catalyst combinations mixed therein. The catalysts or catalyst combinations are normally used in quantities of 0.001 to 5 percent by weight, preferably of 0.05 to 3 percent by weight based on the weight of the polyurethane materials.

In which, for example, the material for forming the base portion 30 may include the catalysts or catalyst combinations having a quantity of greater percent by weight than that for the pad portion 20 of the wrist rest apparatus. such that the base portion 30 may include a hardness greater than that of the pad portion 20 of the wrist rest apparatus. The base portion 30 and the pad portion 20 of the wrist rest apparatus may be formed together by such as the hot-pressing processes, in order to form the prototype 40 as shown in FIG. 6.

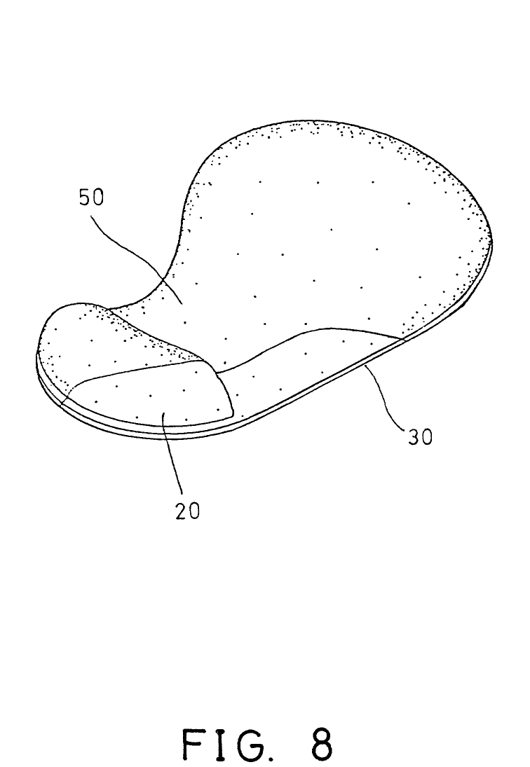

As shown in FIGS. 6 and 7, after the prototype 40 has been formed, the prototype 40 is removed from the mold device 10, and the pad portion 20 is arranged above the base portion 30 of the wrist rest apparatus. Another resilient or soft or deformable or gelatinous material 41, such as gel, or polyurethane (PU), or thermoplastic polyurethane (TPU), or the other gelatinous materials, is then applied or sprayed onto the outer peripheral portion of the pad portion 20 and the base portion 30 of the wrist rest apparatus, for forming a polyurethane skin 50 (FIG. 7) on the outer peripheral portion of the pad portion 20 and the base portion 30 of the wrist rest apparatus.

In which, the material for forming the polyurethane skin 50 may include the catalysts or catalyst combinations having a quantity of greater percent by weight than that for the pad portion 20 of the wrist rest apparatus, such that the polyurethane skin 50 may include a hardness greater than that of the pad portion 20 of the wrist rest apparatus. The polyurethane skin 50 may be formed onto the base portion 30 and the pad portion 20 by such as a heating process, in order to form the final wrist rest apparatus as shown in FIG. 8.

It is to be noted that the gelatinous material 41 is applied or sprayed onto the pad portion 20 and the base portion 30 after the prototype 40 of the pad portion 20 and the base portion 30 has been formed. No peripheral skirt or flange will be formed around or on the outer peripheral portion of the pad portion 20 and the base portion 30 of the wrist rest apparatus, and no trimming processes are required for trimming or removing the peripheral skirt or flange from the wrist rest apparatus as that required for the typical wrist rest apparatus manufacturing method.

Accordingly, the method in accordance with the present invention may be used for manufacturing a wrist rest apparatus having no peripheral skirt or flange formed around the wrist rest apparatus, and for allowing the wrist rest apparatus to be manufactured without final trimming processes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for manufacturing a wrist rest apparatus, said method comprising:
manufacturing a prototype of said wrist rest apparatus with a first gelatinous material, and
applying a second gelatinous material onto an outer peripheral portion of said prototype, for forming a gelatinous skin on said outer peripheral portion of said prototype.

2. The method according to claim 1, wherein said second gelatinous material is sprayed onto said outer peripheral portion of said prototype.

3. The method according to claim 1 further comprising providing a mold device having a mold cavity formed therein, and filling said first gelatinous material into said mold cavity of said mold device for forming said prototype of said wrist rest apparatus.

4. The method according to claim 3, wherein said mold device includes a deeper chamber and a shallower recess formed therein for forming said mold cavity thereof, said method further comprising filling said first gelatinous material into said chamber of said mold device for forming a pad portion of said wrist rest apparatus, and filling said second gelatinous material into said recess of said mold device for forming a base portion of said wrist rest apparatus.

5. The method according to claim 1, wherein said first gelatinous material is a polyurethane material.

6. The method according to claim 1, wherein said second gelatinous material is a polyurethane material.
